(19) United States
(12) Patent Application Publication
(10) Pub. No.: US 2015/0362926 A1
(43) Pub. Date: Dec. 17, 2015

(54) INFORMATION EXCHANGE USING NEAR FIELD COMMUNICATIONS IN HVAC SYSTEM

(71) Applicant: Carrier Corporation, Farmington, CT (US)

(72) Inventors: Bryan M. Yarde, Fort Wayne, IN (US); Michael A. Roher, Fort Wayne, IN (US)

(21) Appl. No.: 14/740,781

(22) Filed: Jun. 16, 2015

Related U.S. Application Data
(60) Provisional application No. 62/012,752, filed on Jun. 16, 2014.
(60) Provisional application No. 62/095,407, filed on Dec. 22, 2014.

(51) Int. Cl. G05D 23/19; G05B 19/042; H04B 5/00

(52) U.S. Cl. CPC G05D 23/1917; H04B 5/0031; G05B 19/042; G05B 2219/2614

(57) ABSTRACT

A method of exchanging parametric data between at least one HVAC component including a first near field communication interface and a second device including a second near field communication interface is provided. The method includes supplying power to the first near field communication interface, and initiating a pairing event between the first near field communication interface and the second near field communication interface. The method also includes exchanging the parametric data between the first near field communication interface and the second near field communication interface.

### CROSS REFERENCE TO RELATED APPLICATIONS

The present application is related to, and claims the priority benefit of, U.S. Provisional Patent Application Ser. No. 62/012,752 and 62/095,407 filed Jun. 16, 2014, the contents of which are hereby incorporated in their entirety into the present disclosure.

### TECHNICAL FIELD OF THE DISCLOSED EMBODIMENTS

The presently disclosed embodiments generally relate to heating, ventilation, and air-conditioning (HVAC) systems, and more particularly, to a system and method of configuring HVAC components in an HVAC system.

### BACKGROUND OF THE DISCLOSED EMBODIMENTS

Generally, HVAC systems have multiple comfort and installation parameters, schedules, and recorded parametric data that can be adjusted, customized or retrieved to allow an installer and/or end user to properly maximize control and comfort of the HVAC system. Comfort and installation parameters and schedules are often both cumbersome and time consuming to adjust and require the installer and/or end user to do so while standing in front of the system control interface. This is normally accomplished by a manual method of entry or manipulation through several screens. This can be a problematic process because of the limitation of screen size operating system, and graphic capability of the system control interface. Additionally, operating and historical data are not easily accessible to service personnel and are generally not available if the control cannot be energized due to any number of failure possibilities. A need remains for a system that enables a user to exchange data between components without having to use the system control interface.

### SUMMARY OF THE DISCLOSED EMBODIMENTS

In one aspect, a method of exchanging parametric data between at least one HVAC component including a first near field communication interface and a second device including a second near field communication interface is provided. The method includes supplying power to the first near field communication interface, and initiating a pairing event between the first near field communication interface and the second near field communication interface. The method also includes exchanging the parametric data between the first near field communication interface and the second near field communication interface.

In one aspect, an HVAC controller is provided including a processor, a memory, a first near field communication interface, and executable software stored in the memory. The executable software is configured to initiate a pairing event between the first near field communication interface and the second near field communication interface. In one embodiment, the pairing event includes the exchange of parametric data between the first near field communication interface and a device including a second near field communication interface.

In one aspect, an HVAC component having a controller is provided. The controller includes a processor, a memory, a first near field communication interface, and executable software stored in the memory. The executable software is configured to initiate a pairing event between the first near field communication interface and the second near field communication interface. In one embodiment, the pairing event includes the exchange of parametric data between the first near field communication interface and a device including a second near field communication interface.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic component diagram of an HVAC system according to the present disclosure; and

FIG. 2 is a schematic flow diagram of a method for configuring at least one HVAC component within an HVAC system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

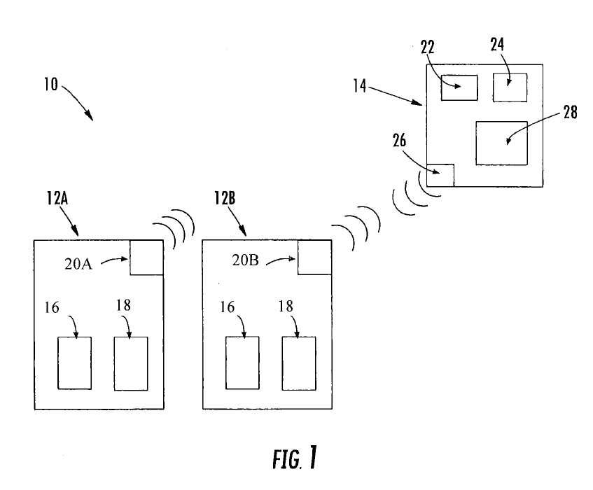

FIG. 1 illustrates an HVAC system in one embodiment, generally referenced at 10. The HVAC system 10 includes at least one HVAC component 12 operably coupled to a power supply source (not shown). In the example shown, the HVAC system 10 includes HVAC components 12A-B. It will be appreciated that the at least one HVAC component 12 may include, but are not limited to, a furnace, a fan coil, an air conditioner, a heat pump, a thermostat, a humidifier, a de-humidifier, and/or a ventilator. In one embodiment, the at least one HVAC components 12 may be in electrical communication with one another. In one embodiment the electrical communication between the at least one HVAC components 12 may be wired or wireless. For example, after the at least one HVAC component 12 is configured, each of the components 12 are installed in electrical communication to operate the HVAC system 10.

In one embodiment, each HVAC component 12 includes a processor 16, a memory 18, for example read only memory (ROM) and electrically erasable programmable read only memory (EEPROM) to name two non-limiting examples, and a near field communication interface 20. In one embodiment, a device 14, for example a mobile device such as a tablet or smart device, includes a processor 22, a memory 24, for example read only memory (ROM) and electrically erasable programmable read only memory (EEPROM) to name two non-limiting examples, and a near field communication interface 26. The device 14 may be a part of the HVAC system 10, for example a mobile control interface or thermostat, or the device 14 may be separate from the HVAC system 10, for example a user's tablet or cell phone. The near field communication interfaces 20 and 26 allow a form of contactless communication between the at least one HVAC component 12 and the device 14. Each HVAC component 12 and the device 14 further include software stored within the memory 18 and 24 respectively, for the execution thereof by the processors 16 and 22 respectively. In one embodiment, the HVAC component 12 includes a display screen (not shown), for example a liquid crystal display (LCD) to name one non-limiting example. In one embodiment, the device 14 includes a display screen 28, for example a liquid crystal display (LCD) to name one non-limiting example.

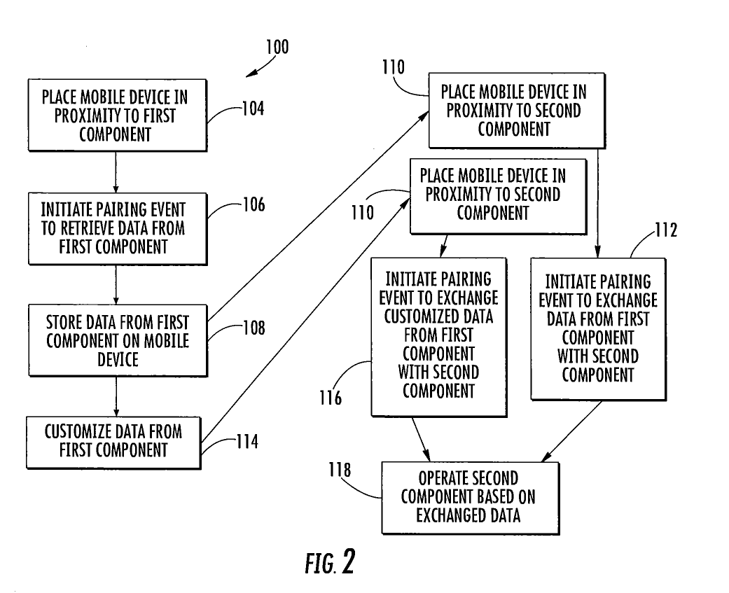

FIG. 2 illustrates a schematic flow diagram of an exemplary method 100 of exchanging parametric data between at least one HVAC component 12 including a first near field communication interface 20 and a second device 14 including a second near field communication interface 26. The method 100 includes the step 104 of placing a device 14 in close proximity to at least one of the HVAC components 12. For example, to retrieve data from the HVAC component 12A, a user or installer may place the device 14 within a distance close enough to communicate with the HVAC component 12A. As the device 14 moves within close proximity of the HVAC component 12A, the near field communication interfaces 20A and 26 may begin communication between the HVAC component 12A and device 14.

In one embodiment, the method 100 includes step 106 of operating the device 14 or the HVAC component 12A to initiate a pairing event. In one embodiment, the pairing event includes an exchange of data between the HVAC component 12A and the device 14. In one embodiment, the exchange of data includes at least one of group consisting of: parameters, settings, configurations, schedules, and recorded parametric data. At step 108, the data is stored within the memory 24 of the device 14.

At step 110, the device 14 is placed in close proximity to another HVAC component 12B. For example, a user or installer may place the device 14 within a distance close enough to communicate with the HVAC component 12B. As the device 14 moves within close proximity of the HVAC component 12B, the near field communication interfaces 20B and 26 may begin communication between the HVAC component 12B and device 14.

In one embodiment, at step 112 the device 14 or the HVAC component 12B initiates a pairing event between the device 14 and the HVAC component 12B. In one embodiment, the pairing event includes an exchange of data between the HVAC component 12B and the device 14. In one embodiment, the exchange of data includes transmitting from the device 14 to the HVAC component 12B the parameters, settings, configurations, schedules, and/or recorded parametric data retrieved from the component 12A.

In at least one embodiment, the method 100 further includes customizing the data retrieved from the at least one HVAC component 12 using the device 14 to create customized data, at step 114. For example, software executed by the device 14 may enable a user to customize the data related to the at least one HVAC component 12 using a touch screen display or the like. The method further includes exchanging the customized data from the device 14 to the at least one HVAC component 12, at step 116. In one embodiment, the method 100 further includes step 118 of operating the at least one HVAC component 12 based on the retrieved data.

It will therefore be appreciated that the disclosed embodiments provide numerous advantages such as allowing the homeowner or installer to transfer current settings, configurations and schedules to and from any of the electronic controls. In at least one embodiment, an interface between a mobile device with near field communication capabilities to any of the HVAC devices is provided. The homeowner/installer may adjust the settings, configurations and schedules from the device 14 in a more convenient setting and then return the new settings, configurations and schedules (via near field communication) from the device back to the at least one HVAC component 12.

The disclosed embodiments provide an improved and more convenient method for modifying and storing settings, configuration and schedules for the homeowner. Predefined settings, configurations and schedules can be used by an installer to load common parameters during commissioning of multiple HVAC systems. The near field communication technology also makes it possible to retrieve fault codes from a control that is no longer functioning, thereby allowing for parametric retrieval not previously possible with traditional implementations. The pairing, configuration, and data retrieval can be accomplished even without applying power to the HVAC system by leveraging the near field communication integrated circuits.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of exchanging parametric data between at least one HVAC component including a first near field communication interface and a second device including a second near field communication interface, the method comprising the steps of:
supplying power to the first near field communication interface;
initiating a pairing event between the first near field communication interface and the second near field communication interface; and
exchanging the parametric data between the first near field communication interface and the second near field communication interface.

2. The method of claim 1, wherein initiating a pairing event comprises placing the first near field communication interface in close proximity to the second near field communication interface in order to initiate communication therebetween.

3. The method of claim 1, wherein the parametric data is adjustable.

4. The method of claim 1, wherein the parametric data includes at least one of parameters, settings, configurations, or schedules.

5. The method of claim 1 further comprising altering the parametric data with the second device to form altered parametric data.

6. The method of claim 5 further comprising exchanging the altered parametric data between the second near field communication interface and the first near field communication interface.

7. The method of claim 1, wherein the at least one HVAC component is in at least one of wired or wireless communication with a second HVAC component.

8. An HVAC controller comprising:
a processor;
a memory;
a first near field communication interface; and
executable software stored in the memory,
wherein the executable software is configured to:
initiate a pairing event; and
exchange parametric data over the first near field communication interface.

9. The HVAC controller of claim 8, wherein the pairing event is initiated by placing the first near field communication interface in close proximity to a device including a second near field communication interface in order to initiate communication therebetween.

10. The HVAC controller of claim 8, wherein the parametric data is adjustable.

11. The HVAC controller of claim 8, wherein the parametric data includes at least one of parameters, settings, configurations, or schedules.

12. An HVAC component having a controller comprising:
a processor;
a memory;
a first near field communication interface; and
executable software stored in the memory,
wherein the executable software is configured to:
initiate a pairing event; and
exchange parametric data over the first near field communication interface.

13. The HVAC component of claim 12, wherein the pairing event is initiated by placing the first near field communication interface in close proximity to a device including a second near field communication interface in order to initiate communication therebetween.

14. The HVAC component of claim 12, wherein the parametric data is adjustable.

15. The HVAC component of claim 12, wherein the parametric data includes at least one of parameters, settings, configurations, or schedules.

16. The HVAC component of claim 12, wherein the HVAC component is in at least one of wired or wireless communication with a second HVAC component.

17. A method of exchanging parametric data between at least one HVAC component including a first near field communication interface and a second device including a second near field communication interface, the method comprising the steps of:
supplying power to the first near field communication interface;
initiating a first pairing event between the first near field communication interface and the second near field communication interface;
exchanging a first set of parametric data between the first near field communication interface and the second near field communication interface;
disconnecting the first pairing event between the first near field communication interface and the second near field communication interface;
editing the first set of parametric data to create a revised set of parametric data;
initiating a second pairing event between the first near field communication interface and the second near field communication interface; and
exchanging the revised set of parametric data between the first near field communication interface and the second near field communication interface.
